(19) United States
(12) Patent Application Publication
(10) Pub. No.: US 2009/0025535 A1
(43) Pub. Date: Jan. 29, 2009

(54) SYSTEM AND METHOD FOR REPRESENTING MUSICAL NOTES IN AN OCTAVE TO THE VISIBLE LIGHT SPECTRUM AND METHOD THEREFOR

(76) Inventor: Ian Montgomery, Tempe, AZ (US)

Correspondence Address: WEISS & MOY PC, 4204 NORTH BROWN AVENUE, SCOTTSDALE, AZ, 85251, US

(21) Appl. No.: 11/781,410

(22) Filed: Jul. 23, 2007

(51) Int. Cl. G09B 15/00

(52) U.S. Cl. 84/477 R

(57) ABSTRACT

A method of graphically representing the musical notes in an octave in parallel to the visible light spectrum, by means of one or more color codes comprising colors in a spectrally sequential order and repeating the code throughout the different octaves, and a series of apparati designed to apply said method, as a note locator, to any type of musical instrument where exactly one auditory tone is modified in pitch by exactly one manipulation of the instrument, including all stringed, keyboard, and melodic percussion instruments.

### FIELD OF THE INVENTION

This invention relates generally to the musical notes and, more specifically, to a system and method of graphically representing the musical notes in an octave in parallel to the visible light spectrum, by means of one or more color codes comprising colors in a spectrally sequential order and repeating the code throughout the different octaves, and a series of apparati designed to apply the method, as a note locator, to any type of musical instrument where exactly one auditory tone is modified in pitch by exactly one manipulation of the instrument, including all stringed, keyboard, and melodic percussion instruments.

### BACKGROUND OF THE INVENTION

When the inventor observed a digital recording of an emission from an infrared LED on a television remote control in late 2001, the digital camera appeared to have transcribed the infrared signal to the visible spectrum in its recording in such a manner that the remote's LED appeared to flash a whitish, slightly violet blue. This made him wonder whether the electromagnetic spectrum would appear to repeat its colors in the same way that different musical octaves repeat the same notes over and over. The invention itself, however, was not inspired until the inventor bought a violin and, wishing to learn how to play it, sought to find and buy a product relating the musical scale to the visible light spectrum in a way that would visually indicate to him the position of every possible note on the string, including but preferably not limited to the twelve notes of the Western scale. Since such a product seemed unavailable, the inventor decided to design and produce one himself. Deriving the spectrally sequential and equidistant color code for the twelve Western notes was simple, and yielded a system adequate to most musical instruments available. However, the inventor's idea is embodied to its maximum on an instrument where infinite (and not only twelve) notes may be played in any octave, and the most well-known of such instruments is the violin. While a twelve-color violin note locator using this system, to make it easier to play in a Western scale, is disclosed in this patent, the maximum embodiment of this visual note representation system assigns at least millions and up to infinite colors to at least millions and up to infinite tones in each octave. After having devised these methods, the inventor began to research past patents pertaining to locating and/or identifying notes on musical instruments. The existing invention most similar to his own employs a spectrally non-sequential color code on some but not all notes, and is only applicable to fretless stringed instruments in particular.

U.S. Pat. No. 6,452,080, issued to Phillip R. Coonce, discloses an apparatus and method for a note locator for stringed instruments. The note locator system helps a user learn correct finger placement by visually identifying colors with notes of the equitempered chromatic scale. Coonce uses a system indicated by lines perpendicular to the strings, colored in a spectrally non-sequential manner, and of a minimal width adequate to display the color of each graphical “fret”. Also, Coonce fails to explicitly identify notes which are not part of the diatonic C-Major/A-minor scale. While Coonce's invention effectively locates notes on a violin fingerboard, it lacks a coherent and versatile note representation system such as the one in this patent, which completely and concisely displays at least all twelve notes and up to infinite tones in any octave and, furthermore, which is applicable to any number of instruments besides fretless stringed instruments. Anyone who wishes to take advantage of such a visual parallel while locating and identifying notes on a fretless stringed instrument (or any of many other types of instruments) would be more satisfied with the invention disclosed in this patent. That presumably smaller portion of musicians who would find such a color-coded representation undesirable, but would still like to locate and identify notes on the fingerboard of their fretless stringed instrument (but not any other type of instrument), would be more satisfied with Coonce's invention.

### SUMMARY OF THE INVENTION

In accordance with one embodiment of the present invention, a method for transcribing musical notes is disclosed. The method comprises: assigning a first color to a first note of a music scale; and assigning colors to the remaining notes in the music scale, wherein a color assigned to each sequential note will be in sequential color order according to a visible light spectrum.

In accordance with another embodiment of the present invention, a note position indicator for a string instrument is disclosed. The note position indicator has a template sized to be positioned on a neck of the stringed instrument. The template is divided into a plurality of segments wherein each segment represents a different note. A color coded note position indicator is formed on a top surface of the template. A first color is assigned to a first note of a music scale and colors are assigned to the remaining notes in the music scale wherein the color assigned to each sequential note will be in sequential color order according to a visible light spectrum, wherein the assigned colors are repeated for different octaves in the music scale.

The present invention is best understood by reference to the following detailed description when read in conjunction with the accompanying drawings.

### BRIEF DESCRIPTION OF THE DRAWINGS

FIG. 1 depicts a graphical note representation method wherein the graphical notes comprise twelve colors, sequential and equidistant on the visible light spectrum;

FIG. 2 depicts a note locator in the shape of the fingerboard of a fretless, stringed instrument using the graphical note representation method of FIG. 1;

FIG. 3 is depicts a note locator using the continually variable color spectrum of graphical note representation method depicted in FIG. 9;

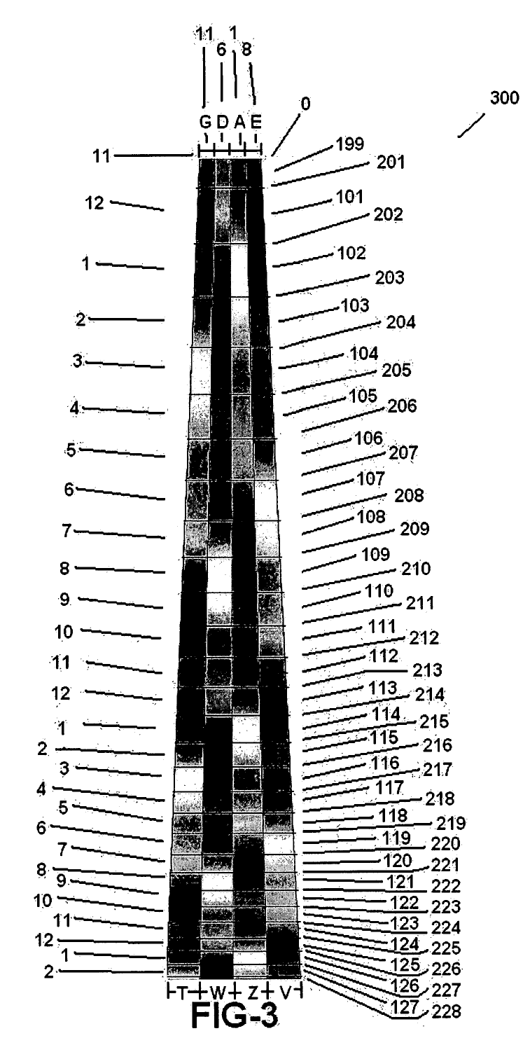

FIG. 4 is another embodiment of a note locator using the continually variable color spectrum of graphical note representation method depicted in FIG. 9;

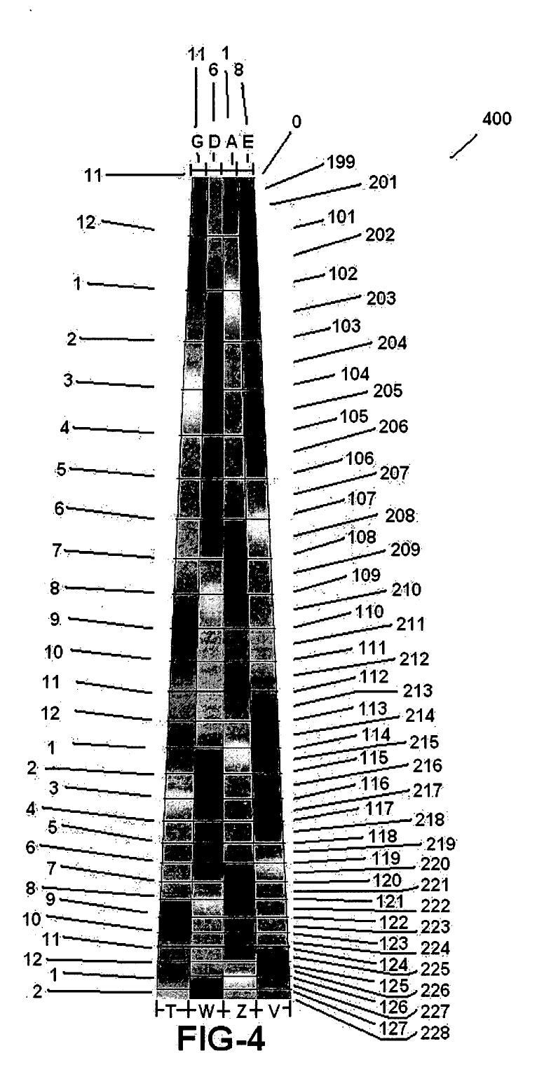

FIG. 5 is another embodiment of a note locator using the continually variable color spectrum of graphical note representation method depicted in FIG. 9;

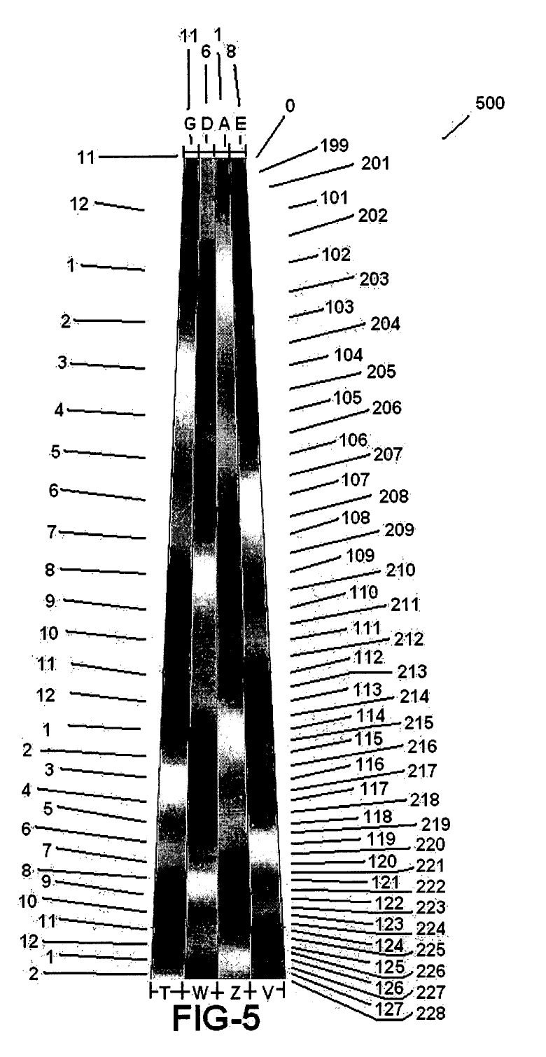

FIG. 6 is an embodiment of a note locator attached to a top surface of piano keys;

FIG. 7 is another embodiment of a note locator that attaches to a top surface of a guitar nut and fretboard;

FIG. 8 is another embodiment of a note locator comprising the note and rest symbols, including whole notes, whole rests, and all fractions thereof, used in standard musical notation;

FIG. 9 depicts another graphical note representation method wherein the graphical notes comprise at least millions of colors and include the twelve colors defined in FIG. 1, sequential and equidistant on the visible light spectrum;

FIG. 10 depicts a scale identifier in accordance with one embodiment; and

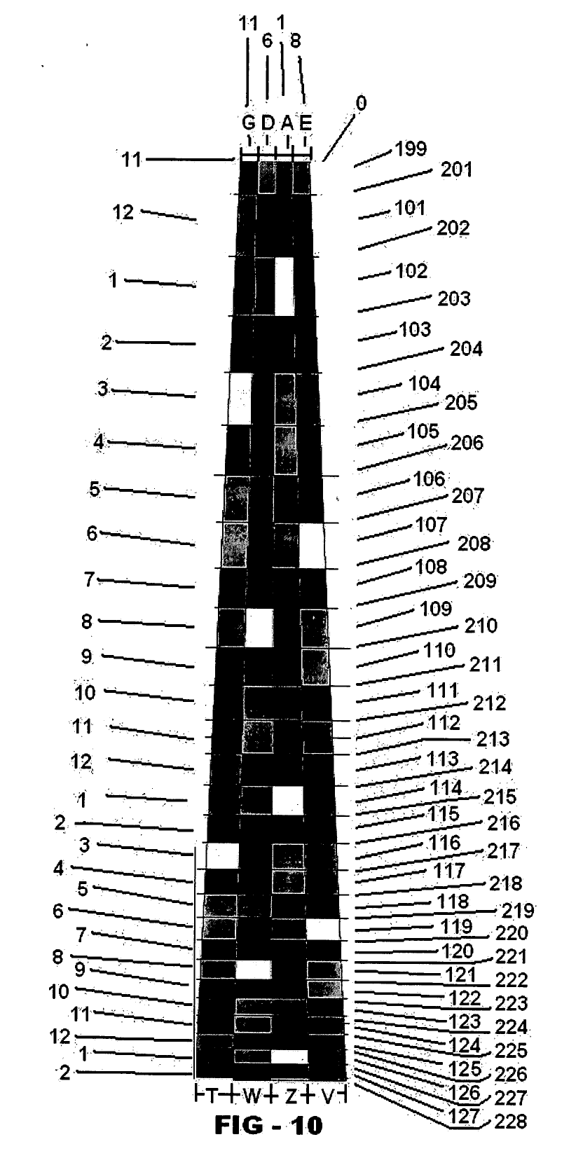

FIG. 11 depicts a scale identifier in accordance with one embodiment.

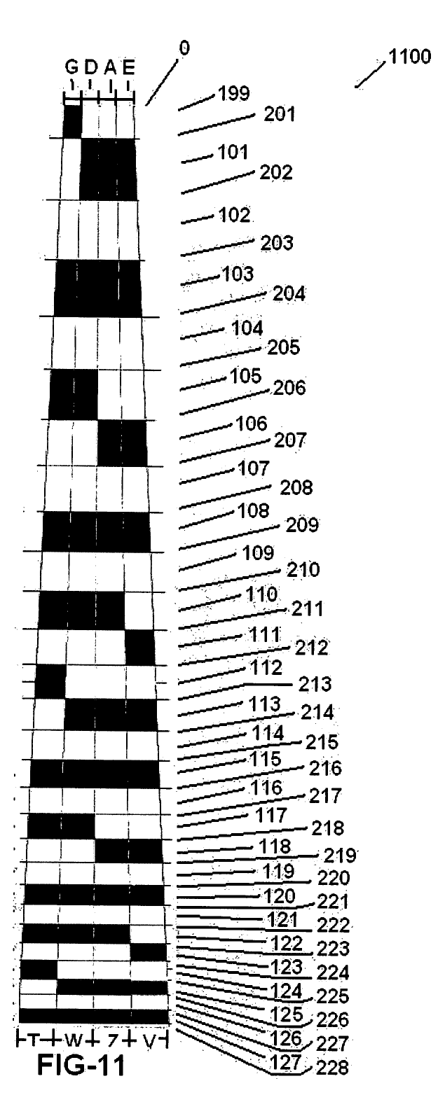

### DETAILED DESCRIPTION

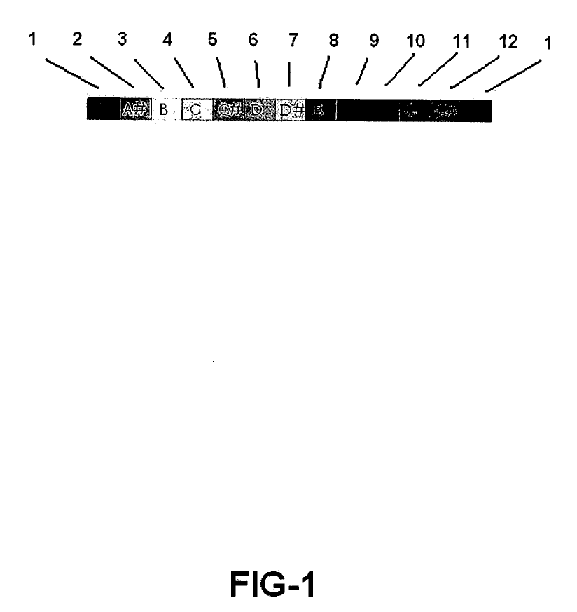

Referring to FIG. 1, graphical note representation method (100) comprises twelve colors, sequential and equidistant on the visible light spectrum. One of the colors is assigned to each of the twelve notes in the Western even-temperament chromatic scale, and the colors repeat themselves along the different octaves in the same manner as the note.

Note representer (1) is assigned to “A”, or 440 Hz, as well as all halves and doubles of 440 Hz, which are all “A” on different octaves. The Red-Green-Blue (RGB) value of the color of note representer (1) is Red: Full, Green: Null, and Blue: Null. Note representer (2) is assigned to “A#/Bb”, and the RGB value of its color is Red: Full, Green: Half, and Blue: Null. Note representer (3) is assigned to “B”, and the RGB value of its color is Red: Full, Green: Full, Blue: Null. Note representer (4) is assigned to “C”, and the RGB value of its color is Red: Half, Green: Full, Blue: Null. Note representer (5) is assigned to “C#/Db”, and the RGB value of its color is Red: Null, Green: Full, Blue: Null. Note representer (6) is assigned to “D”, and the RGB value of its color is Red: Null, Green: Full, Blue: Half. Note representer (7) is assigned to “D#/Eb”, and the RGB value of its color is Red: Null, Green: Full, Blue: Full. Note representer (8) is assigned to “E”, and the RGB value of its color is Red: Null, Green: Half, Blue: Full. Note representer (9) is assigned to “F”, and the RGB value of its color is Red: Null, Green: Null, Blue: Full. Note representer (10) is assigned to “F#/Gb”, and the RGB value of its color is Red: Half, Green: Null, Blue: Full. Note representer (11) is assigned to “G”, and the RGB value of its color is Red: Full, Green: Null, Blue: Full. Note representer (12) is assigned to “G#/Ab”, and the RGB value of its color is Red: Full, Green: Null, Blue: Half.

Since various color palettes comprising different possible numbers of colors are used in different systems, the RGB values given are proportional instead of absolute. “Full” means that the color referred to is set at its highest possible value; “Half” means that the color referred to is set at one half of its highest possible value; “Null” means that the color referred to is set at its lowest possible value. Thus are derived twelve colors, which are all equidistant from one another on the spectrum just as the twelve tones of the chromatic scale are equidistant from one another. In this way, the musical scale can be represented as a spectrum which repeats itself over the octaves, creating an intuitive visual representation of all the musical notes.

While these twelve derived equidistant colors are used on the present apparati which manifest this method, these colors preferably may be modified for a number of purposes. Similar, spectrally sequential codes of color may be adapted to other scale temperaments as necessitated by various different kinds of instruments. The colors of any of these codes may be changed slightly to aid in the contrast among them, or they may be darkened at the lower octaves and gradually brightened toward the higher octaves. However the color codes may be modified, their comprised colors will remain sequential in the order of the visible light spectrum and will repeat with every octave.

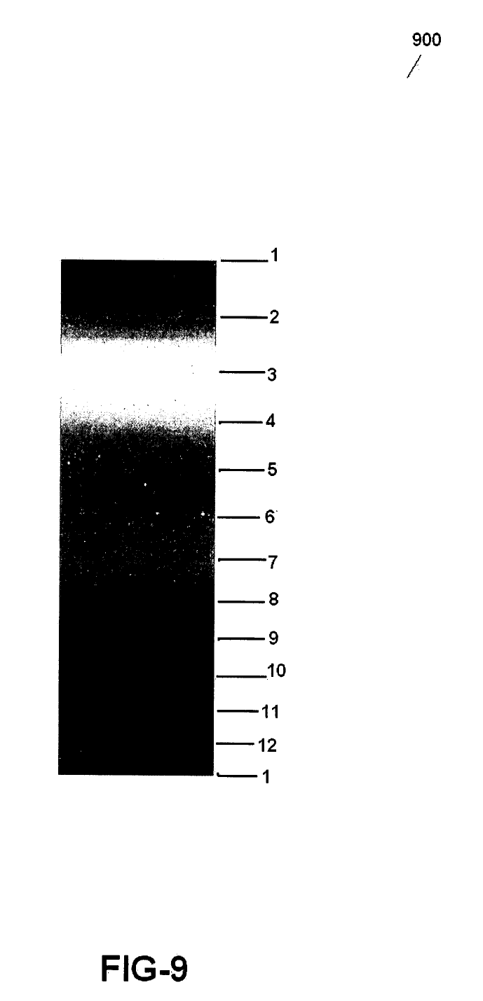

Referring now to FIG. 9, graphical note representation method (900) includes the same twelve colors of graphical note representation method (100), in the same spectrally sequential order and repeated over the various different octaves in the same fashion, except that graphical note representation method (900) comprises in total and including the colors of note representers (1 through 12) at least millions of colors in gradient between note representers (1 through 12), whose functions are to represent at least millions of the infinite auditory tones whose frequencies are between the frequencies of the notes of the Western equal-temperament chromatic scale. Although the 12 colors of note representers (1 through 12) are equidistant on the spectrum, they appear to get closer together toward the higher numbers in FIG. 9 because the graphic used in FIG. 9 to demonstrate graphical note representation method (900) was created for the purpose of testing graphical note representation method (900) on a stringed instrument.

Graphical note representation method (900) is best applied to a musical instrument whose means of pitch modulation is continually varied. This generally includes all fretless stringed instruments. There is no need to modify graphical note representation method (900) to any other scale temperaments besides the Western even-temperament twelve-tone chromatic scale, as no particular temperament is inherent in its form. Graphical note representation method (900) is the purest visual representation of the musical scale, and can be used to play music in any scale temperament of any number of tones.

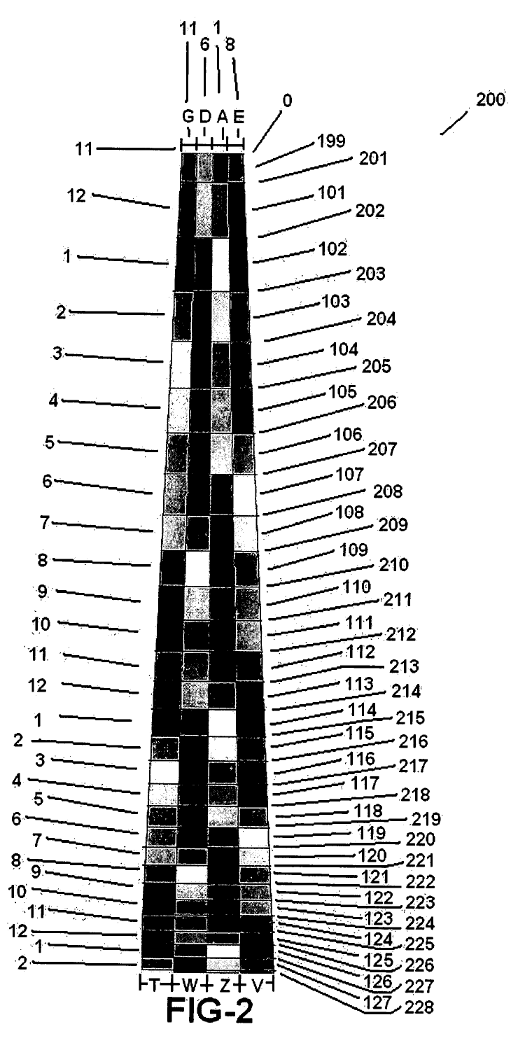

Referring to FIG. 2, note locator (200) comprises a flexible planar top and bottom surface in the shape of the fingerboard of a fretless, stringed instrument: in the case of the diagram in FIG. 2, a violin. The material of which the flexible planar top and bottom surface is made would preferably be durable and moisture-proof, such as vinyl or mylar or another durable material capable of being formed into a flexible planar top and bottom surface. On the bottom side of the surface is an adhesive adequate to attach the planar surface securely but preferably not permanently to the fingerboard of a fretless stringed instrument of the corresponding size and tuning. The adhesive is protected by a removable backing which will be removed and discarded at the time of application. Perforations may preferably be put in the backing in a line perpendicular to the length of the fingerboard near the nut edge (0) in order to facilitate application of note locator (200) without loosening or removing the strings of the instrument. On the top side of the surface is an image similar or identical, depending on the type of fretless stringed instrument, to the image shown in FIG. 2, which comprises graphical note representation method (100) applied to the positions of the notes on a fretless, stringed instrument.

The top surface of note locator (200) comprises the area defined by the space between the nut edge (0) and the edge toward the bridge at note position indicator border (228), by the space between the outer or far edges of widths (G) and (E), comprising by definition widths (D) and (A). When note locator (200) is applied to a violin, widths (G, D, A, and E) will run underneath the G, D, A, and E strings to widths (T, W, Z and V) respectively.

In order to make the note locators as accurate as possible, the middle point between each note representer (1 through 12) in graphical note representation method (900), was moved from a distance of 50% between them, to 59% from the adjacent note representer (1 through 12) of lower pitch, and 41% from the adjacent note representer (1 through 12) of higher pitch. This is truer to the nature of the scale, whose center in the key of “A” (represented by note representer (1)) is “D#/Eb” (represented by note representer (7)), and is always approximately 59% of the total distance from its nearest lower-pitched “A” toward its nearest higher-pitched “A”, and approximately 41% of the distance from its nearest higher-pitched “A” toward its nearest lower-pitched “A”. The center of any scale of any key, on any vibrating string, is always at this distance between the higher and lower key notes of the scale, and the microtone (or odd-numbered tones of the twenty-four tone equal-temperament scale) between any two notes of the Western chromatic scale is always this distance from the higher and lower tones in relation to it. Furthermore, each forty-eighth tone would be at this distance from the higher and lower twenty-fourth tones adjacent to it, and so on to the most infinitesimal fractions of a scale that could ever be measured or conceived.

This method of defining the center between two points on a vibrating string by auditory tonal or pitch equidistance rather than by spatial equidistance, and whose spatial position correlating to the auditory tonal or pitch equidistance is always approximately 59% of the spatial distance from the point whence a note lower in pitch is sounded, and approximately 41% of the spatial distance from the point whence a note higher in pitch is sounded, is henceforth referred to throughout this provisional patent as “octave center”.

While the above method is the best way to suit graphical note representation method (900) to any stringed instrument, graphical note representation method (900) would be best displayed for its general applicability to music, in such a manner where all note representers occur at equal distances, or at 50% of the distance from one another.

Open string indicator (199) comprises the space between the nut edge (0) and note position indicator border (201), wherein the notes sounded by open strings G, D, A, and E, are represented by the colors of note representers (11, 6, 1, and 8), respectively. Note position indicator (101) comprises the exact octave center between note position indicator borders (201 and 202), wherein the notes sounded by the strings G, D, A, and E, when pressed against the fingerboard at the octave center of note position indicator (101), will sound as G#, D#, A#, and F, and are represented by the colors of note representers (12, 7, 2, and 9), respectively. Said colored note representers fill the space between note position indicator borders (201 and 202). Note position indicator (102) comprises the exact octave center between note position indicator borders (202 and 203), wherein the notes sounded by the strings G, D, A, and E, when pressed against the fingerboard at the octave center of note position indicator (102), will sound as A, E, B, and F#, and are represented by the colors of note representers (1, 8, 3, and 10), respectively. Said colored note representers fill the space between note position indicator borders (202 and 203). Just as the numbers of the note position indicators (101 through 127) increment by one as they are found further from the nut edge (0), the numbers of the note representers on each note position indicator will also increment by exactly one, only never reaching 13, but cycling back to 1 from 12 just as the octave cycles back to A from G#. In this way, the four different notes of the four different strings are represented by the colors of four distinct and respective note representers on each note position indicator. Furthermore, the interval between strings is represented graphically along the width of the fingerboard at all points throughout the length of the fingerboard, not only on the open strings.

The placement of the note position indicators (101 through 127) and note position indicator borders (201 through 228) is calculated preferably to the most precise degree feasible using the following formula, which is useful for locating any note on a scale of any temperament on any vibrating string:

Aₙ=L−(L/[1/2^{t}]ⁿ)

Where Aₙ is the length from the inner face of the nut to note position indicator (101 through 127) n (the first note position indicator (101) from the nut would assign to n a value of 1, the second note position indicator (102) would assign to n a value of 2, and so on through the twenty-seventh note position indicator (127), which would assign to n a value of 27), L is the length of the vibrating string from the inner face of the nut (0) to the inner face of the bridge, which is essentially (further calculation may be employed to determine the precise length of string that will actually be vibrating, which would render a 30 cm scale length approximately 29.9 cm vibrating) the scale length of whichever stringed instrument on which a note locator similar to note locator (200) is to be placed, t is the temperament of the scale to be used, i.e. the number of semitones comprised by each octave of the scale (the Western equal-temperament chromatic scale will assign to t a value of 12 for the purpose of calculating the positions of note position indicators (101 through 127), but will assign to t a value of 24 for the purpose of calculating the positions of note position indicator borders (201 through 228), which are preferably located in the exact octave center of the space between their surrounding, respective note position indicators (101 through 127)), and n is the number of note position indicators (101 through 127) plus one that are located between note position indicator (101 through 127) n and nut (0).

The precise locations, i.e. distances from the nut and bridge, of note position indicator borders (201 through 228) are calculated using the above mentioned formula, where t is equal to 24 instead of 12. This is because a 24-tone equal temperament scale comprises, on the even-numbered notes from the nut (i.e. 2, 4, 6), the notes of the 12-tone equal temperament scale. The odd-numbered notes from the nut in the 24-tone equal temperament scale correspond to the equally spaced semitones between the notes, or microtones, of the 12-tone equal temperament scale. On a fretless stringed instrument, the microtones of the scales are located in the exact octave center between the semitones actually comprised by the scale. Likewise, the semitones actually comprised by any scale are always located in the exact octave center between their respective surrounding microtones.

In this way, the note position indicators (101 through 127) are in the octave center of the blocks of color comprised by note representers (1 through 12) on note locator (200). This note location system is distinct from that disclosed in U.S. Pat. No. 6,452,080, which indicates by means of lines perpendicular to the strings, colored in a spectrally non-sequential manner, and of a minimal width adequate to display the color of each graphical “fret”, wherein five of the twelve chromatic notes share the same color: white, whose RGB value is Red: Full, Green: Full, and Blue: Full. In note locator (200), the precise position of the finger stopping the string necessary to produce each note of the Western 12-tone equal-temperament scale is not indicated on the precise spot where the finger is to be placed (the finger will cover this spot and render it invisible at the time of use); it is rather highlighted by the note position indicator borders (201 through 228), and is located in the exact octave center of them. Thus precise finger placement for note position indicator (101 through 127) is not explicitly indicated on note locators (200, 300 and 500), only on note locator (400), though it is necessary to precisely calculate its positions in order to manufacture note locators (300 through 500). In order to manufacture note locator (200), it is only necessary to calculate the precise positions of note position indicator borders (201 through 228). Although the precise finger placement in the center of each of the color blocks comprising note representers (1 through 12) is precisely at the positions of note position indicators (101 through 127), the color-blocked design of note locator (200) is kept to its simplest, most aesthetically pleasing, most elegant, and least confusing form possible by refraining from including explicit graphical representation of note position indicators (101 through 127). This is also intuitive to any musician experienced in fretted stringed instruments, since musicians tend to fret, or stop the strings with their fingers behind the fret or frets corresponding to the tone or tones they wish to produce, in the area furthest from the frets and nearest to the center between them rather than in the area nearest to the frets, thus the superiority of note locator (200)'s method of precisely highlighting the correct finger placements at note position indicators (101 through 127) by means of note position indicator borders (201 through 228), over the method of any note locator similar to U.S. Pat. No. 6,452,080, should be apparent to anyone skilled in the art.

Note locators (300 through 500) comprise the continually variable color spectrum of graphical note representation method (900), which comprises millions of colors running from red through green and blue and back again to red. On this continually varied spectrum comprised by note locators (300 through 500), the precise colors comprised by note representers (1 through 12) are encountered exactly at the positions of note position indicators (101 through 127). The colors found between note position indicators (101 through 127) are consistent representations of the semitones found between the twelve tones of the Western equal-temperament chromatic scale.

Note locators (300 and 400) are identical to note locator (500) except that note locator (300) indicates in an explicit graphical manner the locations of note position indicator borders (201 through 228) by means of black lines running perpendicular to the strings at the exact positions of note position indicator borders (201 through 228), and that note locator (400) indicates in an explicit graphical manner the locations of note position indicators (101 through 127) by means of black lines running perpendicular to the strings at the exact positions of note position indicators (101 through 127).

Although the color “red” has been chosen to represent “A”, this method of graphically representing the musical scale with a series of colors in sequential spectral order repeated over the octaves, may feature the scale beginning with any color—not necessarily red. These graphical note representation methods (100 and 900) could preferably be “tuned” when used with electronic devices of such a nature as to permit it: for example, a colored musical ambient lighting system, a sight-reading computer program, or an electronic, colored, under lit note locator, could all make use of graphical note representation methods (100 and 900), but feature an additional means to change which note is represented by “red”, or which color represents “A”. In this way, a student, listener, or automated device or program could potentially tune the device to begin graphical note representation methods (100 and 900) with “red” representing whichever key in which he or she plans to play or listen, whether the key of A or of G or of D# or any other.

Furthermore, those note locators (200, 300, 400, 500, 600, 700) comprising a flexible planar surface with an adhesive protected by a removable backing on one side and graphical note representation method (100) on the other, could all be published in a potential infinity of versions, merely changing the color-to-note reference point: for example, having “A” represented instead by the color of note representer (2, 3, 4, 5, 6, 7, 8, 9, 10, 11, or 12), in which case “B” would have to be represented instead by the color of note representer (4, 5, 6, 7, 8, 9, 10, 11, 12, 1, or 2), respectively.

Absolutely which note aligns with which color as a reference point is not important. It is merely important that twelve colors in sequential spectral order correspond to the twelve chromatic notes in the order of the musical scale and repeat over the octaves.

Although graphical note representation method (100) is the base from which the entire note representation and location system comprised by the patent has sprung, the most advanced and innovative manifestation of this method is comprised by graphical note representation method (900), which is comprised by note locator (500) and its derivatives, note locators (300 and 400).

Since the violin, as any other fretless stringed instrument, is not limited by any scale temperament inherent in its construction, as is the majority of other musical instruments, it is capable of producing an infinity of tones between the high and low notes of any octave not merely twelve equidistant tones. The best way to represent the continually variant infinity of notes on each string of the violin is by means of a continually varied spectrum of millions of colors or more, wherein preferably every auditory tone possible in each octave corresponds to exactly one color of the visible light spectrum. The unique innovativeness of this graphical note representation method (900) that parallels the color spectrum to the acoustic scale in a “one-to-one” manner should be apparent to anyone skilled in the art.

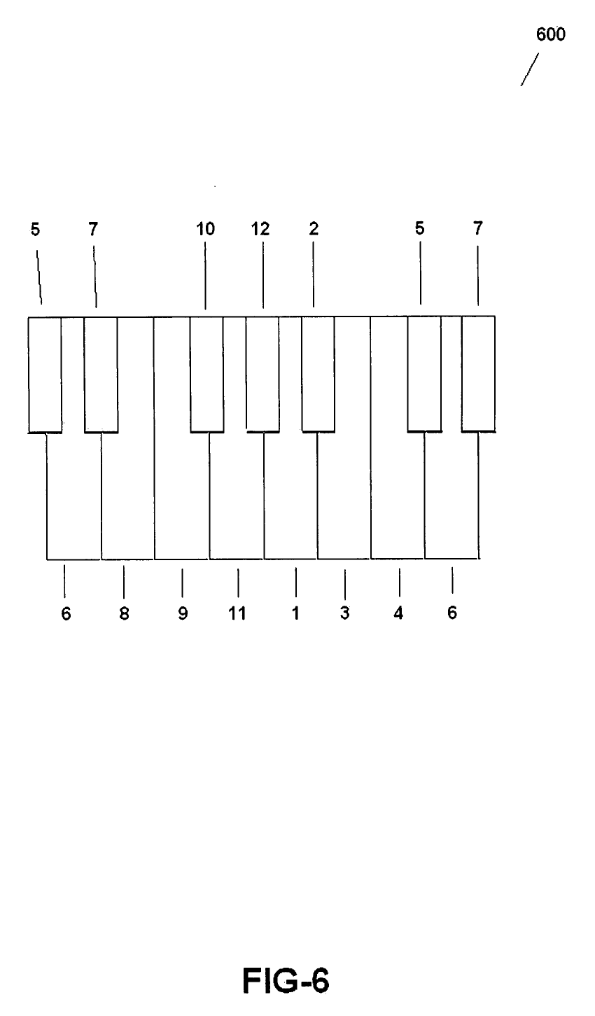

Graphical note representation method (100), as mentioned above, can be applied to any number of musical instruments. Referring to FIG. 6, note locator (600) comprises a series of top and bottom planar surfaces which are not necessarily flexible, and are shaped and sized to fit precisely over the top surfaces of the keys of the piano, whose bottom surfaces comprise an adhesive adequate to attach note locator (600) to the top surfaces of piano keys securely but preferably not permanently, and whose top surfaces comprise exactly one of each note representer (1 through 12) as corresponds to the note sounded by each respective key.

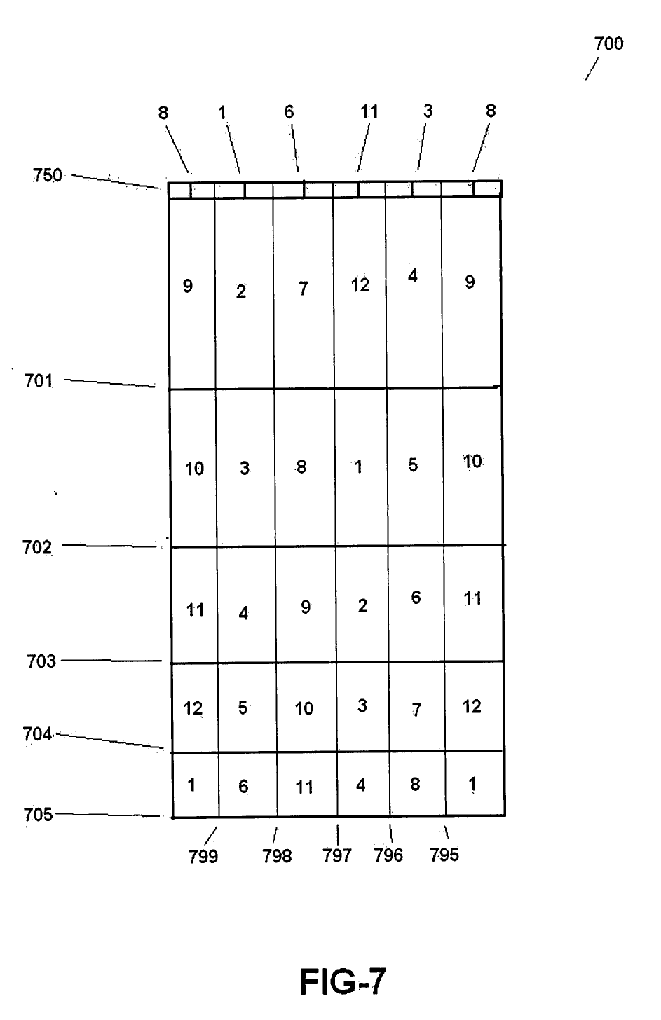

Referring to FIG. 7, note locator (700) comprises a series of top and bottom flexible planar surfaces, shaped and sized to fit precisely over the top surfaces of preferably the guitar's nut (750) and certainly the guitar's fretboard between and up to the frets (701 through 705). The bottom surfaces will comprise an adhesive adequate to attach note locator (700) securely but preferably not permanently to the top surfaces of the guitar's nut and fretboard. The top surfaces will comprise exactly six of the note representers (1 through 12), divided by note representer borders (795 through 799) in such a way that each note representer is found beneath the string on the fret of its corresponding note. The appropriate colors comprised by note representers (1 through 12) appropriate to the note locators to be placed on the top surfaces of the nut and the fingerboard between the first few frets are represented in FIG. 7. Most preferably, all note representers (1 through 12) displayed on note locator (700) would feature the color of each note representer (1 through 12) at the exact center between note representer borders (795 through 799), with a color gradient fading from the center toward the next higher note representer (1 through 12) near the note representer borders, in such a way so that bending a string of the fretted stringed instrument to which note locator (700) is applied will always correspond in pitch to the color directly below the string, as per graphical note representation method (900). This would have either to be approximated to a general common string gauge and/or made available for a number of different string gauges. Calculations to include these bent-string note locators have not yet been made by the inventor.

Note locators could be made for musical instruments which make use of other scale temperaments, even irregular temperaments, such as that to which the sitar is tuned. A graphical representation method derived using the same principles used to derive graphical note representation method (100), would have to be derived from a spectrum made in the most preferred form of graphical note representation method (900), which is specified further below. Just as the percentage distance of each note representer (1 through 12) along the spectrum is equal to the percentage distance of each represented note (“A” through “G#/Ab”) along the scale, any other graphical note representation method similar to graphical note representation method (100) but comprising a scale different from the Western twelve tone equal temperament “chromatic” scale, would preferably assign colors to the notes in a similarly proportional manner, paralleling the visible light spectrum to the audio scale in a one-to-one manner. Although the colors would be different from those featured in graphical note representation method (100), they would still be in spectrally sequential order and repeated over each octave, which is the main unique and innovative quality of this entire invention.

Note locators (200, 300, 400, 500, and 700), as well as any similar note locators comprising graphical representation methods (100 and/or 900), will preferably feature a horizontal excess, or overlap, of flexible planar material with adhesive on the bottom surface, for the purpose of further securing note locator (200, 300, 400, 500, 700 or similar) to the fingerboard and neck: this excess or overlap will be smoothed against the sides of the fingerboard and neck of any stringed instrument for which it be designed and to which it be applied, and will make undesired or premature detachment of note locator (200, 300, 400, 500, or 700) much less probable.

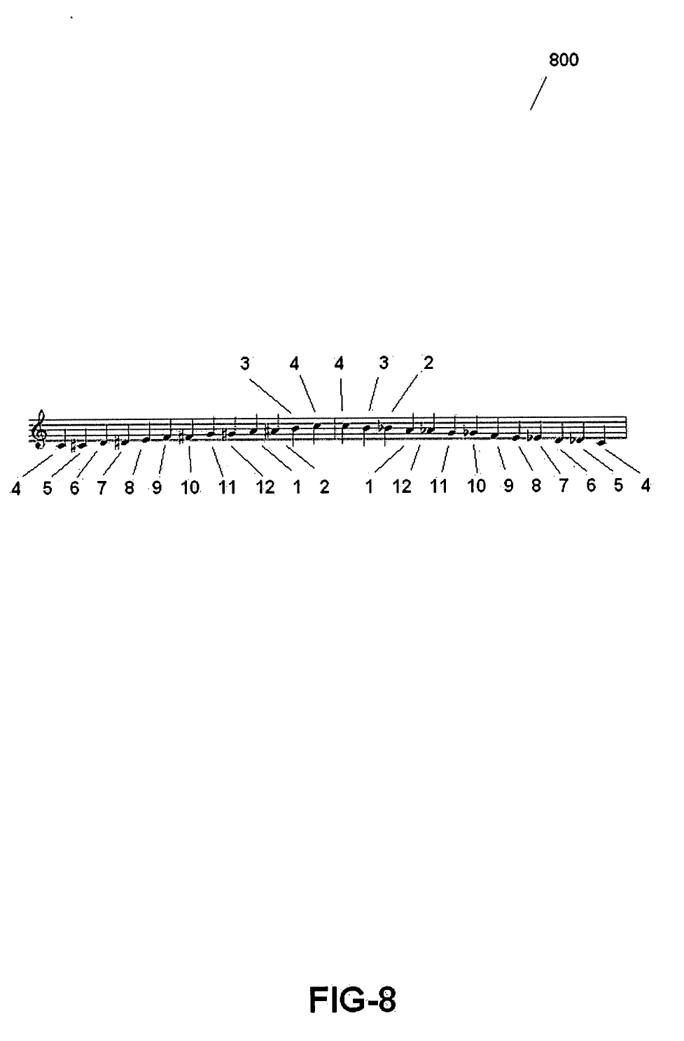

Referring to FIG. 8, note locator (800) comprises the note and rest symbols, including whole notes, whole rests, and all fractions thereof, used in standard musical notation, to be colored to the appropriate colors comprised by note representers (1 through 12) as indicated in FIG. 8. This method may have to be modified slightly in order to make the lighter colors (such as note representer (3)) visible against a white background, perhaps by means of black or color-inverted outlines.

The graphics used to demonstrate graphical note representation method (900) and note locators (300, 400 and 500) may created with the color gradient utility of a popular computer imaging program such as Adobe Photoshop. Since the gradient utility places colors along a percent of the total gradient, the correct placement of each color in the gradient was the percentage of its distance from the lowest note in each octave to the highest note in each octave, reached by dividing the distance of any note (whose positions on the fingerboard are represented by note position indicators (101 through 127)) from the first note in the octave, by the total length of the octave. The octave lengths are very simply calculated:

Lₙ=(1/2ⁿ)L.

Where L is the scale length of the instrument, preferably calculated for the vibrating portion of the string only, and Lₙ is the length of the n^{th} octave from the nut. There are infinite octaves on every string, but only the few nearest the nut are long enough to be played accurately by human hands.

The first octave is half the scale length, the second is a fourth, the third is an eighth, and so on. The percentages of the distance of each note from the first note in the octave to the last, were found by calculation to be equal throughout the nearly three octaves comprised by the fingerboard of the violin. The gradient utility only allowed color placement on the gradient at a precision of one per cent of the gradient's length: in the case of graphical note representation method (900) and of note locators (300, 400 and 500), this is the length of each octave of which any portion is featured on note locators (300, 400 and 500). Although this level of precision is lower than the preferred level of precision, it was sufficient to create a reasonably well-working prototype which can be demonstrated in function to the satisfaction of anyone who wonders about its purpose or questions its effectiveness.

Preferably, generation of graphical note representation method (900) would dispense entirely with Photoshop and its gradient utility and would employ a computer program, if not already existing, then devised for this particular invention, to generate a full visible spectrum of color. For display purposes intended to demonstrate the applicability of the method to music in general and not only to fretless stringed instruments in particular, as mentioned above, it would preferably be generated in such a manner where all note representers occur at equal distances from one another.

However, in order to generate a completely accurate continually varied note locator along a string's scale length, it is necessary to apply a curve to the distances between colors, as demonstrated in the following formula:

y=L−L/2^{x}

Where L is the scale length, or distance from the nut to the bridge of any stringed instrument, y is the distance from the nut to the position of the note, note representer, and color being calculated for on the fretboard of the instrument (the position of the nut is y=0 and the position of the bridge is y=L), and x is the note sounded by the open string. In the diagram of graphical note representation method (900) shown in FIG. 9, x would be “A”, represented by note representer (1). x=0 is the open string, x=1 is exactly one octave above x=0, x=2 is exactly two octaves above x=0, and so on. On the twelve-tone equal temperament scale, all the other notes on the scale between the octaves would correspond to each of the twelfth fractions between each integer of x, and their positions as a distance between the nut toward the bridge will be equal to y. A computer generation of a visible light spectrum of the highest feasible resolution, repeated to the highest degree permitted by the resolution, between two points and according to the above formula, would generate a version of graphical note representation method (900) that is entirely precise, and superior to the one presently shown in FIG. 9.

Scale Identifier (1100), shown in FIG. (11), comprises a transparent flexible planar surface with or without an adhesive on one side protected by a removable backing, and a series of opaqued trapezoids on the top surface placed in such a way as to block the colors of note representers on note locators (200-500) which are not part of the desired scale, or in the case of scale identifier (11), A Major. In FIG. (10), Scale Identifier (1100) is shown as it would appear placed over note locator (200), with only those note representers visible which represent part of the A Major diatonic scale. Scale Identifier (1100) will preferably be modified to accommodate all major types of scales, including Major, Minor, Pentatonic, Suspended, Augmented and Diminished scales in all possible keys. It will preferably be mounted on top of a note locator (200-500) as securely as possible while still being temporarily attached, i.e. reasonably easily removable and replaceable. The scale identifier may or may not make use of a relatively weak adhesive, or it may be printed on a surface designed to cling by static electricity, or by whichever method available to the inventor is proven most effective.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A method for transcribing musical notes comprising:
assigning a first color to a first note of a music scale; and
assigning colors to the remaining notes in the music scale, wherein the color assigned to each sequential note will be in sequential color order according to a visible light spectrum.

2. The method of claim 1 further comprising repeating the assigned colors for different octaves in the music scale.

3. The method of claim 2 further comprising using the assigned colors to locate notes upon a stringed instrument using the assigned colors as note position indicators.

4. The method of claim 3 wherein using the assigned colors to locate notes upon a stringed instrument comprises:
forming a template to be positioned on a neck of the stringed instrument;
dividing the template into a plurality of segments wherein each segment represents a different note; and
placing the assigned colors upon the template in each of the plurality of segments as note position indicators.

5. The method of claim 4 wherein using the assigned colors to locate notes upon a stringed instrument further comprises positioning each note position indicator at an octave center between note position indicator borders.

6. The method of claim 5 wherein placing the assigned colors upon the template in each of the plurality of segments as note position indicators comprises calculating placement of the note position indicators and note position indicator borders using the formula:
Aₙ=L−(L/[1/2^{t}]ⁿ)
where Aₙ is the length from an inner face of a nut to the note position indicator n, L is a length of a vibrating string from an inner face of the nut to the inner face of a bridge, t is the temperament of a scale to be used, the number of semitones comprised by each octave of the scale, and n is the number of note position indicators plus one that are located between note position indicator n and nut (0).

7. The method of claim 6 further comprising:
using a Western (twelve tone) equal-temperament chromatic scale as the music scale; assigning to t a value of 12 for the purpose of calculating positions of the note position indicators; and
assigning to t a value of 24 for the purpose of calculating positions of the note position indicator borders.

8. The method of claim 2 further comprising using the assigned colors to locate notes upon a keyboard instrument using the assigned colors as note position indicators.

9. The method of claim 8 further comprising:
forming a template to be positioned on top surfaces of a plurality of keys of a keyboard; and
placing the assigned colors upon the template on each top surface of each key as note position indicators, each note position indicator corresponding to the note sounded by each respective key.

10. A note position indicator for a string instrument comprising:
a template sized to be positioned on a neck of the stringed instrument, wherein the template is divided into a plurality of segments, each segment represents a different note; and
a color coded note position indicator formed on a top surface of the template, wherein a first color is assigned to a first note of a music scale and colors are assigned to the remaining notes in the music scale, the color assigned to each sequential note will be in sequential color order according to a visible light spectrum, wherein the assigned colors are repeated for different octaves in the music scale.

11. A note position indicator for a string instrument in accordance with claim 10 wherein the assigned colors are positioned at an octave center between note position indicator borders.

12. A note position indicator for a string instrument in accordance with claim 11 wherein placing the assigned colors at an octave center between note position indicator borders is calculated using the formula:
Aₙ=L−(L/[1/2^{t}]ⁿ)
where Aₙ is the length from an inner face of a nut to the note position indicator n, L is a length of a vibrating string from an inner face of the nut to the inner face of a bridge, t is the temperament of a scale to be used, the number of semitones comprised by each octave of the scale, and n is the number of note position indicators plus one that are located between note position indicator n and nut (0).

13. A note position indicator for a string instrument in accordance with claim 12 wherein the music scale is a Western equal-temperament chromatic scale, a value of 12 is assigned to t for a purpose of calculating positions of the note position indicators and a value of 24 is assigned to t for calculating positions of the note position indicator borders.

14. A method for transcribing musical notes comprising:
assigning a first color to a first note of a music scale;
assigning colors to the remaining notes in the music scale, wherein the color assigned to each sequential note will be in sequential color order according to a visible light spectrum; and repeating the assigned colors for different octaves in the music scale;
using the assigned colors to locate notes upon a stringed instrument by forming a template to be positioned on a neck of the stringed instrument;
dividing the template into a plurality of segments wherein each segment represents a different note; and
placing the assigned colors upon the template in each of the plurality of segments as note position indicators.

15. The method of claim 14 wherein using the assigned colors to locate notes upon a stringed instrument further comprises positioning each note position indicator at an octave center between note position indicator borders.

16. The method of claim 5 wherein placing the assigned colors upon the template in each of the plurality of segments as note position indicators comprises calculating placement of the note position indicators and note position indicator borders using the formula:
Aₙ=L−(L/[1/2^{t}]ⁿ)
where Aₙ is the length from an inner face of a nut to the note position indicator n, L is a length of a vibrating string from an inner face of the nut to the inner face of a bridge, t is the temperament of a scale to be used, the number of semitones comprised by each octave of the scale, and n is the number of note position indicators plus one that are located between note position indicator n and nut (0).

17. The method of claim 16 further comprising:
using a Western equal-temperament chromatic scale as the muisic scale; assigning to t a value of 12 for the purpose of calculating positions of the note position indicators; and
assigning to t a value of 24 for the purpose of calculating positions of the note position indicator borders.
